(19) United States
(12) Patent Application Publication
(10) Pub. No.: US 2015/0375413 A1
(43) Pub. Date: Dec. 31, 2015

(54) SLICER

(71) Applicant: BENRINER CO., LTD, YAMAGUCHI (JP)

(72) Inventor: Hajime YAMAMOTO, Yamaguchi (JP)

(21) Appl. No.: 14/539,282

(22) Filed: Nov. 12, 2014

(30) Foreign Application Priority Data
Jun. 30, 2014 (JP) 2014-133578

(51) Int. Cl. B26D 3/28

(52) U.S. Cl. CPC B26D 3/283; B26D 2003/286

(57) ABSTRACT

A slicer that can be used for a long period of time by suppressing a fastening failure of a fastening bolt for use in securing a slicing blade to a frame. A slicer 1 provided with a slicing blade fixing mechanism 100 having an embedded nut 110 made of metal that is disposed on the rear side of a slicing blade 20, and also disposed inside a nut attaching hole 18 that is communicated with a slit 16, and a fastening bolt 120 that is disposed on the surface side of the slicing blade 20, and is meshed with the embedded nut 110, while being inserted into a bolt hole 21 formed on an end portion of the slicing blade.

### BACKGROUND OF THE INVENTION

1. Field of the Invention

The present invention relates to a slicer for slicing a material to be sliced, such as a vegetable, fruit or the like, and in particular concerns a slicer in which a slicing blade is freely detachably attached to a frame.

2. Description of the Related Art

Conventionally, as a slicer for use in easily slicing various materials to be sliced, such as vegetables, fruits or the like, into sliced pieces having a desired width, such a slicer has been used in which the material to be sliced is reciprocally moved forward and rearward in the slicing direction so as to slice the material to be sliced by using a slicing blade.

As a conventional slicer, such a slicer has been known which is provided with a frame made of resin having a pair of right and left supporting arms, a slicing blade that is freely detachably attached to the supporting arms, a fixed slicing blade that is disposed on the front side of the slicing blade and passed between the paired right and left supporting arms, and a movable supporting plate disposed on the rear side of the slicing blade (see JP-A No. 2004-338069).

In this slicer, the slicing blade is freely detachably attached to a frame by using bolts that are meshed with screw holes formed by a tapping process at desired positions in accordance with attaching positions of the slicing blade. With this arrangement, since a slicing blade that has been used for a long time and worn can be sharpened, or since a used slicing blade can be exchanged to a new slicing blade, it is possible to continuously use a slicer for a long period of time.

[Patent Document 1] JP-A No. 2004-338069

In the case of the above-mentioned slicer, however, the screw hole is worn out due to repeated attaching and detaching processes of the slicing blade, to sometimes cause a so-called fastening failure of the bolt in which the bolt fails to be desirably meshed with the screw hole to cause an unstable engaged state of the bolt with the screw hole. When the screw hole is further worn out to cause a failure in securing the slicing blade to the frame, the resulting problem is that the slicer can no longer be used thereafter.

For this reason, technical problems are raised in an attempt to provide a slicer that can be used for a long period of time by suppressing the fastening failure of the fastening bolt for use in securing the slicing blade to the frame, and the object of the present invention is to solve these problems.

### SUMMARY OF THE INVENTION

The present invention, which has been proposed to achieve the above object, includes an invention according to One embodiment that provides a slicer having: a slicing blade for slicing a material to be sliced; a frame made of resin having a pair of supporting arms provided with slits for housing two ends of the slicing blade; and a slicing blade fixing mechanism for securing two ends of the slicing blade to the paired supporting arms, and in this structure, the slicing blade fixing mechanism is provided with an embedded nut made of metal that is disposed on one of the surface side and the rear side of the slicing blade, and also disposed inside a nut attaching hole that is communicated with the slit, and a fastening bolt that is disposed on the front side or the rear side of the slicing blade, and is meshed with the embedded nut, while being inserted into a bolt hole formed on an end portion of the slicing blade.

In accordance with this structure, since the fastening bolt is meshed with an embedded nut having a hardness higher than that of a conventional frame made of resin so that it is possible to prevent one of the fastening bolt and the embedded nut from wearing extremely in comparison with the other, and even in the case when the fastening bolt is repeatedly tightened and loosened, it is possible to suppress the fastening failure in the fastening bolt, and the fastening bolt can secure the slicing blade for a long period of time. Moreover, since the embedded nut is locally disposed on one portion of the supporting arm, it becomes possible to improve the durability of the slicer at low costs.

An invention disclosed in one embodiment provides a slicer in which, in addition to the structure of the slicer of another embodiment, the embedded nut is insert-molded with the frame and anchored thereto.

In accordance with this structure, since the embedded nut is firmly anchored to the frame, it is possible to prevent the embedded nut from idling inside the nut attaching hole at the time of tightening/loosening the fastening bolt so that the fastening bolt can positively secure the slicing blade.

An invention disclosed in another embodiment provides a slicer in which, in addition to the structure of the slicer of other embodiments, the embedded nut is disposed on the rear side of the slicing blade, and the fastening bolt is disposed on the surface side of the slicing blade, with the head portion of the fastening bolt being housed in a bolt housing hole formed on the surface of the supporting arm.

In accordance with this structure, since the fastening bolt is housed in the bolt attaching hole, without the head portion of the fastening bolt being made to protrude from the surface of the frame, it is possible to prevent the fastening bolt from being undesirably loosened by receiving an external force caused when the head portion of the fastening bolt is made in contact with a material to be sliced, or the like so that the fastening bolt can positively secure the slicing blade.

An invention disclosed in one embodiment provides a slicer in which, in addition to the structure of the slicer of another embodiment, the head portion of the fastening bolt is housed in the bolt housing hole, with the top surface of the head portion being kept substantially on the same level as the surface of the supporting arm.

In accordance with this structure, since the top surface of the fastening bolt is position-determined on substantially the same level as that of the surface of the supporting arm, it is possible to prevent the fastening bolt from being undesirably loosened by receiving an external force, making it possible to positively secure the slicing blade and also to suppress cut chips of the material to be sliced from remaining inside the bolt housing hole; thus, the slicer can be used sanitarily.

### Effects of the Invention

The slicer in accordance with the present invention makes it possible to suppress a fastening failure of the fastening bolt caused by repeatedly tightening and loosening the fastening bolt, and consequently to improve the durability of the slicer; thus, it becomes possible to use the slicer for a long period of time.

### BRIEF DESCRIPTION OF THE DRAWINGS

FIG. 1 is a perspective view showing a slicer in accordance with one embodiment of the present invention.

FIG. 2 is an exploded view of the slicer shown in FIG. 1.

FIG. 3 is a perspective view showing a frame and a fixed supporting plate of FIG. 1.

FIG. 4, which are drawings showing the frame and the fixed supporting plate of FIG. 3, include FIG. 4A that is a left side view; FIG. 4B that is a plan view; and FIG. 4C that is a right side view.

FIG. 5 is a schematic view showing a state before a slicing blade is secured onto the frame.

FIG. 6 is a schematic view showing a state in which the slicing blade has been secured onto the frame.

FIG. 7 is a cross-sectional view taken along line VII-VII of FIG. 6.

### DETAILED DESCRIPTION OF THE PREFERRED EMBODIMENTS

In order to achieve the object of the present invention for providing a slicer that can be used for a long period of time by preventing a fastening bolt for use in securing a slicing blade to a frame from causing a fastening failure, a slicer of the present invention, which is provided with a slicing blade for slicing a material to be sliced, a frame made of resin having a pair of supporting arms provided with slits for housing the two ends of the slicing blade, and a slicing blade fixing mechanism for securing the two ends of the slicing blade to the paired supporting arms, has a structure in which the slicing blade fixing mechanism is provided with an embedded nut made of metal that is disposed on one of the surface side and the rear side of the slicing blade, and also disposed inside a nut attaching hole that is communicated with the slit, and a fastening bolt that is disposed on the other of the front side or the rear side of the slicing blade, and is meshed with the embedded nut, while being inserted into a bolt hole formed on an end portion of the slicing blade; thus, the object of the present invention is realized.

### EMBODIMENTS

Referring to FIGS., the following description will discuss a slicer 1 relating to one embodiment in accordance with the present invention. Additionally, in the following description, terms “front” and “rear” correspond to the front side and the rear side in a slicing direction that is coincident with a feeding direction of a material to be sliced at the time of slicing the material to be sliced. Moreover, terms “up” and “down” correspond to the upper side and the downward side in a direction perpendicular to the slicer. Furthermore, terms “right” and “left” correspond to the right side and the left side facing the slicing direction.

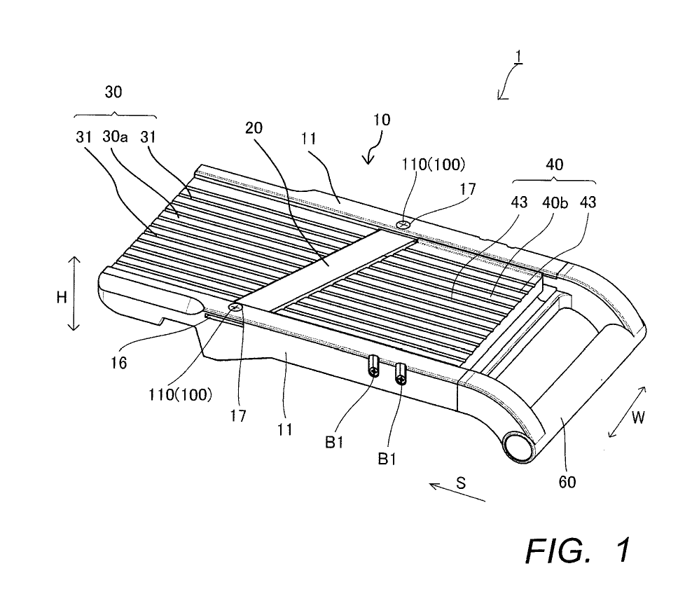

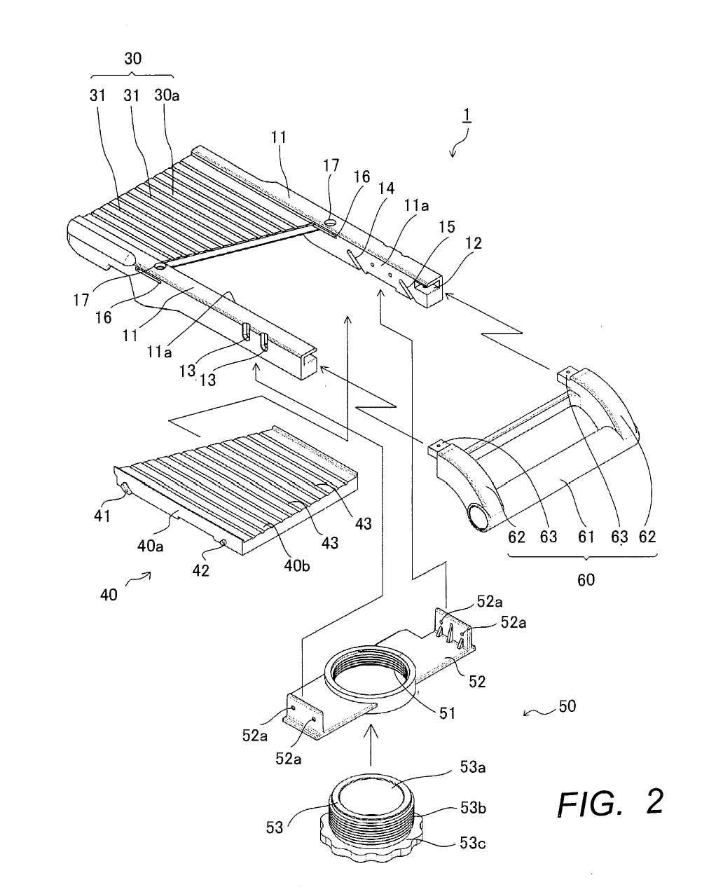

As shown in FIGS. 1 and 2, the slicer 1 is provided with a frame 10 having a pair of right and left supporting arms 11, a slicing blade 20 that is secured to the frame 10 by a slicing blade fixing mechanism 100 so as to slice the material to be sliced, a fixed supporting plate 30 that is disposed on the front side of the slicing blade 20, a movable supporting plate 40 disposed on the rear side of the slicing blade 20, a slice width adjusting mechanism 50 that position-determines the movable supporting plate 40 at a desired position in the vertical direction H, and a grip 60 that is fastened to the frame 10 by using bolts, not shown. The frame 10, the fixed supporting plate 30, the movable supporting plate 40 and the grip 60 are respectively made of ABS resin, and produced by an injection molding process. The slicing blade 20 is made of stainless steel.

The slicer 1 is designed such that when a user reciprocally moves a material to be sliced in a slicing direction S while pressing the material to be sliced onto the movable supporting plate 40, the material to be sliced is sliced into sliced pieces having a thickness in accordance with a gap between the slicing blade 20 and the movable supporting plate 40. The sliced pieces are discharged from the rear side of the slicer 1.

The slicing blade 20 is extended diagonally relative to the width direction W of the frame 10. On the two ends of the slicing blade 20, bolt holes 21 to be described later are respectively formed. The slicing blade 20 is fastened to the frame 10 by fastening bolts 120 inserted through the bolt holes 21.

The fixed supporting plate 30 is disposed between a pair of supporting arms 11, and integrally attached to the supporting arms 11. On the surface 30a of the fixed supporting plate 30, 11 rows of groove portions 31 are engraved and formed side by side in the width direction W in an extended manner in the slicing direction S. By forming the groove portions 31 on the surface 30a of the fixed supporting plate 30, the fixed supporting plate 30 and the material to be sliced are made in contact with each other with a reduced area so that the material to be sliced can be reciprocally moved smoothly. The depth dimension of the groove portions 31 may be desirably determined.

The movable supporting plate 40 is provided with a front pin 41 to be guided, which is formed on the front side of a side face 40a so as to protrude therefrom, and a rear pin 40 to be guided, which is formed on the rear side of the side face 40a so as to protrude therefrom. The front pin 41 to be guided is meshed with a front guide groove 14 to be described later of the supporting arm 11. The rear pin 42 to be guided is meshed with a rear guide groove 15 to be described later of the supporting arm. The movable supporting plate 40 is raised/lowered in accordance with the shapes of the front guide groove 14 and the rear guide groove 15 so that wobbling and twisting of the movable supporting plate 40 are regulated.

The movable supporting plate 40 is provided with 11 rows of groove portions 43 that are engraved and formed on a surface 40b so as to be placed side by side in the width direction W in an extended manner in the slicing direction S. By forming the groove portions 43, the ground contact area between the movable supporting plate 40 and the material to be sliced is reduced correspondingly so that the sliding resistance upon slicing the material to be sliced is reduced.

The slice width adjusting mechanism 50 is capable of adjusting the slice width by raising/lowering the movable supporting plate 40 relative to the slicing blade 20. The slice width adjusting mechanism 50 is constituted by a stay 52 that is provided with a receiving hole 51 and passed between the paired supporting arms 11, and a slice width adjusting dial 53 that can be meshed with the screw receiving hole 51.

The screw receiving hole 51, which is disposed in the center of the stay 52, is designed to be placed below the movable supporting plate 40, when the stay 52 is attached to the frame 10.

The stay 52 is detachably attached to the frame 10, and when bolts 31 are meshed with a screw hole 11d of the frame 10 and screw hole 52a of the stay 52, the stay 52 is secured onto the frame 10.

The slice width adjusting dial 53 is provided with a main body unit 53a having a hollow cylindrical shape, a screw portion 53b formed on an outer peripheral surface of the main body unit 53a and a handle 53c formed on the base end of the main body unit 53a.

When the user holds the handle 53c and rotates it, with the screw portion 53b being meshed with the screw receiving hole 51, the slice width adjusting dial 53 is raised/lowered relative to the stay 62. Thus, the movable supporting plate 40 is raised/lowered while maintaining its horizontal attitude, with its rear surface being supported by the slice width adjusting dial 63, so that the gap between the slicing blade 20 and the movable supporting plate 40, that is, the slice width, can be desirably adjusted.

The grip 60 is provided with a grip portion 61 to be held by the user, and connecting portions 62 that are connected to the rear ends of the paired right and left supporting arms 11 that are formed on the two ends of the grip portion 61. In the present embodiment, the grip 60 is fastened by bolts, not shown, with a tip convex portion 63 being fitted to a rear end concave portion 12 of each of the supporting arms 11. Additionally, the grip 60 is not limited by a structure to be fastened with bolts as long as it is secured to the supporting arms 11, and the grip 60 may be integrally formed with the supporting arms 11.

Additionally, an exchange blade, not shown, may be attached to the slicer 1. The exchange blade is attached between the slicing blade 20 and the movable supporting plate 40. The exchange blade is provided with a plurality of teeth formed on the exchange blade in the longitudinal direction, and the two ends thereof are supported by the frame 10, with these teeth facing upward. The exchange blade is used for forming notches on the material to be sliced along the slicing direction S in accordance with the gap of the teeth, and by using the slicing blade 20 and the exchange blade in combination with each other, the material to be slice can be sliced into stick shapes and rectangular strip shapes having various sizes.

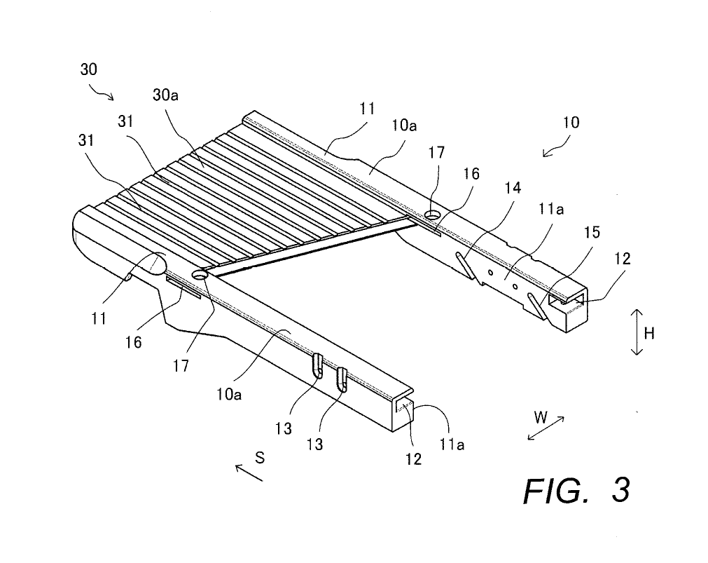

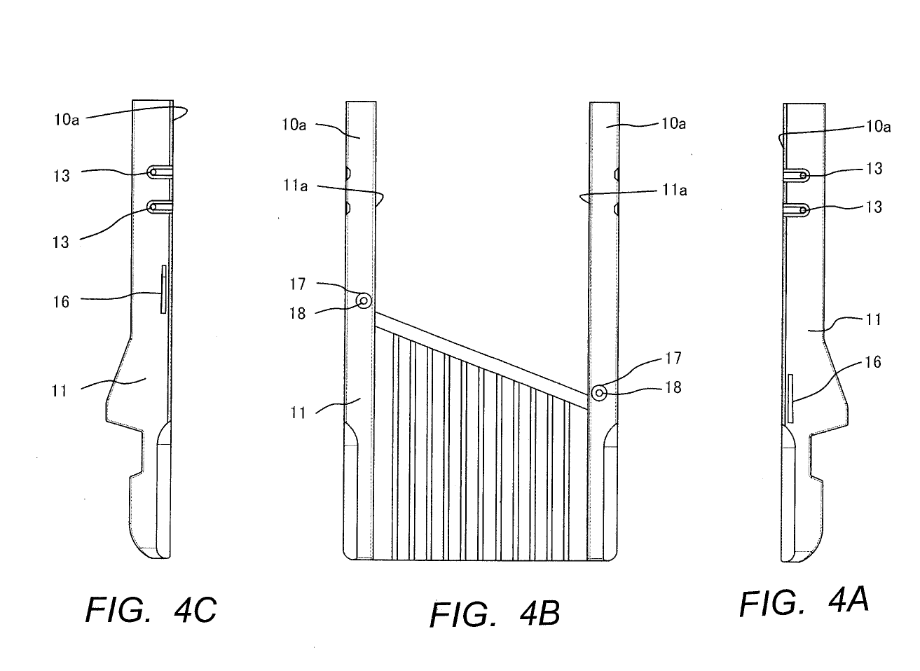

As shown in FIG. 3 as well as FIGS. 4A, 4B, and 4C, the frame 10 is provided with the paired right and left supporting arms 11 that are attached to the two ends of the fixed supporting plate 30 in the width direction. Additionally, reference numeral 12 in FIG. 3 and FIG. 4 represents a rear end concave portion capable of being meshed with a connecting convex portion 63 of the grip 60, and reference numeral 13 represents a screw hole that is meshed with a bolt, not shown, inserted through each of the screw holes 52a of the stay 52.

On each of the supporting arms 11, a front guide groove 14 and a rear guide groove 15 are formed on an inner side face 11a as concave portions. The front guide groove 14 and the rear guide groove 15 are formed in a manner so as to extend diagonally from the rear side toward the front side in the slicing direction S upward in the vertical direction H. The front guide groove 14 is meshed with the front pin 41 to be guided of the movable supporting plate 40. Moreover, the rear guide groove 15 is meshed with the rear pin 42 to be guided of the movable supporting plate 40. Additionally, the shapes of the front guide groove 14 and the rear guide groove 15 may be desirably determined. Since the lower portion of the front guide groove 14 and the lower portion of the rear guide groove 15 are formed as openings, the movable supporting plate 40 can be detachably attached to the frame 10.

On each of the supporting arms 11, a slit 16 for use in housing the end portion of the slicing blade 20 is formed so as to penetrate in the width direction W. The slit 16 is formed diagonally relative to the width direction W in accordance with the shape of the slicing blade 20.

Moreover, each of the supporting arms 11 is provided with a bolt housing hole 17 disposed above the slit 16 and a nut attaching hole 18 disposed below the slit 16. The bolt housing hole 17 is formed so as to penetrate the supporting arm 11 from the surface 10a of the frame 10 to the slit 16. The nut attaching hole 18 is formed coaxially with the bolt housing hole 17 as a concave portion that communicates with the slit 16 so as to have a diameter smaller than that of the bolt housing hole 17. Additionally, with respect to the bolt housing hole 17 and the nut attaching hole 18, not limited to the structure in which the bolt housing hole 17 is formed above (surface side) the slicing blade 20, with the nut attaching hole 18 being formed below (rear side) of the slicing blade 20, the bolt housing hole 17 may be below (rear side) of the slicing blade 20, with the nut attaching hole 18 being formed above (surface side) the slicing blade 20.

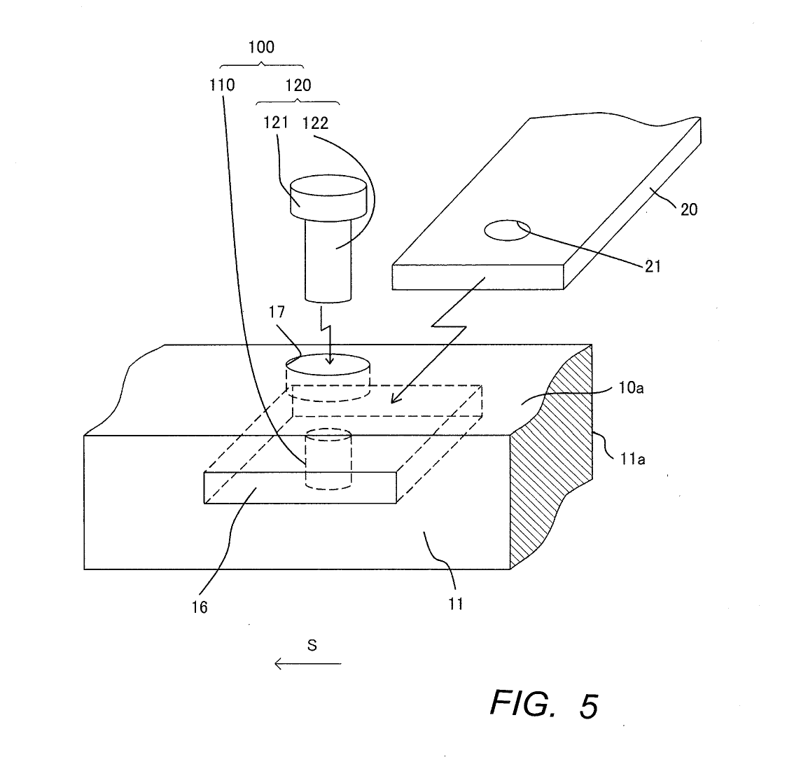

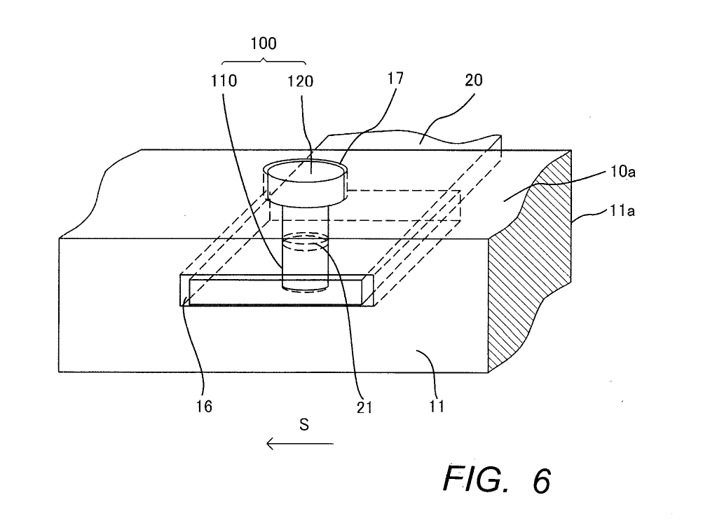

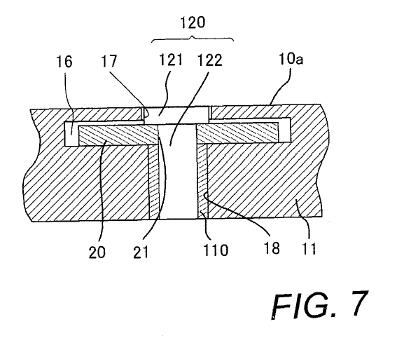

Next, referring to FIGS. 5 to 7, the following description will discuss the slicing blade fixing mechanism 100. FIGS. 5 to 7 are views that schematically show the frame 10, the slicing blade 20 and the slicing blade fixing mechanism 100. FIG. 5 is a view showing a state before the slicing blade 20 is attached to the frame 10. FIG. 6 is a view showing a state in which the slicing blade 20 is attached to the frame 10. FIG. 7 is a cross-sectional view showing the slicing blade fixing mechanism 100.

As shown in FIG. 5, the slicing blade fixing mechanism 100 is constituted by an embedded nut 110 housed in the nut attaching hole 18 and a fastening bolt 120 capable of being meshed with the embedded nut 110.

The embedded nut 110 is formed into a cylindrical shape, and a threaded portion, not shown, is formed on the inner peripheral surface. The embedded nut 110 may be made of any material having a hardness higher than that of the frame 10 made of the ABS resin, and is preferably made of, for example, metal, such as brass. Not limited to the cylindrical shape, the embedded nut 110 may be formed into, for example, a polygonal pillar shape.

The embedded nut 110 is embedded in the frame 10, and in the present embodiment, the embedded nut 110 is insert-molded; however, after forming the frame 10 by using an injection molding process, the embedded nut 110 may be joined thereto separately. For example, another structure may be proposed in which, screw portions are formed on the inner peripheral surface and the outer peripheral surface of the embedded nut 110 formed into a cylindrical shape, and after the embedded nut 110 has been secured to the frame 10 by engaging the screw on the outer peripheral surface with the frame 10, the fastening bolt 120 is threadedly engaged with the thread on the inner peripheral surface of the embedded nut 110 so that the fastening bolt 110 is secured onto the frame 10.

The fastening bolt 120 is provided with a head portion 121 with a top surface formed horizontally, and a shaft portion 122 having a screw portion, not shown, formed on the outer periphery thereof.

As shown in FIG. 6, after the end portion of the slicing blade 20 has been inserted into the slit 11a, the shaft portion 122 of the fastening bolt 120 is inserted through the bolt hole 21 of the slicing blade 20, with the fastening bolt 120 being meshed with the embedded nut 110, so that the slicing blade 20 is secured onto the frame 10.

In accordance with this structure, by allowing the embedded nut 110 to be meshed with the fastening bolt 120, the embedded nut 110 is prevented from wearing in comparison with a conventional slicer in which the screw hole having a lower hardness than that of the fastening bolt tends to wear extremely; therefore, even in the case when the slicing blade 20 is attached/detached repeatedly, it is possible to suppress a fastening failure of the fastening bolt 120 so that the fastening bolt 120 can secure the slicing blade 20 for a long period of time.

Moreover, since the embedded nut 110 is tightly anchored in the frame 10 by the insert molding process, the embedded nut 110 of the fastening bolt 120 is prevented from idling inside the nut attaching hole 18 at the time of tightening and loosening the fastening bolt 120 so that the fastening bolt 120 makes it possible to positively secure the slicing blade 20.

Furthermore, since the embedded nut 110 is locally disposed on one portion of the supporting arm 11, it becomes possible to improve the durability of the slicer 1 at low costs.

As shown in FIG. 7, the head portion 121 of the fastening bolt 120 is preferably housed inside the bolt housing hole 17 of the frame 10. In particular, it is more preferably housed therein, with the top surface of the head portion 121 being kept substantially on the same level as the surface 10a of the frame 10. Thus, since it is possible to prevent the fastening bolt 120 from being undesirably loosened by receiving an external force caused when the head portion 121 of the fastening bolt is made in contact with a material to be sliced, or the like, the fastening bolt 120 makes it possible to positively secure the slicing blade 20. Moreover, by preventing cut chips of the material to be sliced from remaining inside the bolt housing hole 17, it becomes possible to use the slicer 1 sanitarily.

In this manner, the slicer 1 in accordance with the present embodiment makes it possible to prevent a fastening failure of the fastening bolt 120 caused by repeatedly tightening and loosening the fastening bolt 120, and consequently to improve the durability of the slicer 1; thus, it becomes possible to use the slicer 1 for a long period of time.

Additionally, in the present invention, various modifications may be made within the scope without departing from the gist of the present invention, and those modifications are of course included within the scope of the present invention.

### EXPLANATIONS OF REFERENCE NUMERALS

1 SLICER
10 FRAME
10a SURFACE (OF FRAME)
11 SUPPORTING ARM
11a INSIDE SURFACE
12 REAR END CONCAVE PORTION
13 SCREW HOLE
14 FRONT GUIDE GROOVE
15 REAR GUIDE GROOVE
16 SLIT
17 BOLT HOUSING HOLE
18 NUT ATTACHING HOLE
20 SLICING BLADE
21 BOLT HOLE
30 FIXED SUPPORTING PLATE
30a SURFACE (OF FIXED SUPPORTING PLATE)
31 GROOVE PORTION (OF FIXED SUPPORTING PLATE)
40 MOVABLE SUPPORTING PLATE
40a SIDE FACE
40b SURFACE (OF MOVABLE SUPPORTING PLATE)
41 FRONT PIN TO BE GUIDED
42 REAR PIN TO BE GUIDED
43 GROOVE PORTION (OF MOVABLE SUPPORTING PLATE)
50 SLICE WIDTH ADJUSTING MECHANISM
51 SCREW RECEIVING HOLE
52 STAY
52a SCREW HOLE
53 SLICE WIDTH ADJUSTING DIAL
53a MAIN BODY UNIT
53c HANDLE
60 GRIP
61 GRIP PORTION
62 CONNECTION PORTION
63 TIP CONVEX PORTION
100 SLICING BLADE FIXING MECHANISM
110 EMBEDDED NUT
120 FASTENING BOLT
121 HEAD PORTION
122 SHAFT PORTION
S SLICING DIRECTION
W WIDTH DIRECTION
H VERTICAL DIRECTION

What is claimed is:

1. A slicer comprising: a slicing blade for slicing a material to be sliced; a frame made of resin having a pair of supporting arms provided with slits for housing two ends of the slicing blade; and a slicing blade fixing mechanism for securing two ends of the slicing blade to the paired supporting arms,
wherein the slicing blade fixing mechanism comprises an embedded nut made of metal that is disposed on one of the surface side and the rear side of the slicing blade, and also disposed inside a nut attaching hole that is communicated with the slit, and a fastening bolt that is disposed on the front side or the rear side of the slicing blade, and is meshed with the embedded nut, while being inserted into a bolt hole formed on an end portion of the slicing blade.

2. The slicer according to claim 1, wherein the embedded nut is insert-molded and anchored to the frame.

3. The slicer according to claim 1, wherein the embedded nut is disposed on the rear side of the slicing blade, and the fastening bolt is disposed on the surface side of the slicing blade, with the head portion of the fastening bolt being housed in a bolt housing hole formed on the surface of the supporting arm.

4. The slicer according to claim 3, wherein the head portion of the fastening bolt is housed in the bolt housing hole, with the top surface of the head portion being kept substantially on the same level as the surface of the supporting arm.
